(19) United States
(12) Patent Application Publication
(10) Pub. No.: US 2023/0249311 A1
(43) Pub. Date: Aug. 10, 2023

(54) SURFACE IRREGULARITY REDUCING METHOD AND SURFACE IRREGULARITY REDUCING APPARATUS

(71) Applicant: DISCO CORPORATION, Tokyo (JP)

(72) Inventors: Satoshi GENDA, Tokyo (JP); Yujiro SUDO, Tokyo (JP)

(21) Appl. No.: 18/165,058

(22) Filed: Feb. 6, 2023

(30) Foreign Application Priority Data
Feb. 9, 2022 (JP) 2022-018937

(51) Int. Cl. B24B 37/04; B23K 26/38; B23K 26/00

(52) U.S. Cl. CPC B24B 37/042; B23K 26/38; B23K 26/0006; B23K 26/0093

(57) ABSTRACT

A surface irregularity reducing method includes a holding step of holding a first workpiece on a first holder and holding a second workpiece that is of the same material as the first workpiece on a second holder, and a surface irregularity reducing step of moving the first holder and the second holder relatively to each other while the first workpiece held on the first holder and the second workpiece held on the second holder are being kept in contact with each other, thereby removing surface irregularities of a contact surface of at least either the first workpiece or the second workpiece.

### BACKGROUND OF THE INVENTION

### Field of the Invention

The present invention relates to a surface irregularity reducing method and a surface irregularity reducing apparatus.

### Description of the Related Art

It is a general practice to use a grinding wheel or a polishing pad for processing workpieces flatwise. Grinding wheels or polishing pads are also generally used to planarize ingots after wafers have been peeled off therefrom and also to planarize workpieces such as wafers peeled off from ingots as disclosed in Japanese Patent Laid-open No. 2019-029382 and Japanese Patent Laid-open No. 2019-161037.

### SUMMARY OF THE INVENTION

However, some workpiece materials impose limitations on grinding wheels and polishing pads that are available to process themselves well, and have made it difficult in some cases to remove surface irregularities from workpieces made of those materials.

It is therefore an object of the present invention to provide a surface irregularity reducing method and a surface irregularity reducing apparatus that can reduce surface irregularities from workpieces efficiently at lower costs irrespectively of the materials that the workpieces are made of.

In accordance with an aspect of the present invention, there is provided a surface irregularity reducing method including a holding step of holding a first workpiece on a first holder and holding a second workpiece that is of the same material as the first workpiece on a second holder, and a surface irregularity reducing step of moving the first holder and the second holder relatively to each other while the first workpiece held on the first holder and the second workpiece held on the second holder are being kept in contact with each other, thereby removing surface irregularities of a contact surface of at least either the first workpiece or the second workpiece.

Preferably, the surface irregularity reducing method further includes, after the surface irregularity reducing step, a grinding step of grinding the contact surface of at least either the first workpiece or the second workpiece with a grinding wheel.

Preferably, the surface irregularity reducing step includes a step of controlling a pressure under which the first workpiece and the second workpiece are pressed against each other.

Preferably, the surface irregularity reducing method further includes, before the holding step, a peel-off layer producing step of producing peel-off layers in an ingot by applying a laser beam having a wavelength transmittable through the ingot to the ingot while positioning a focused spot of the laser beam in the ingot at a depth from an end face of the ingot, the depth corresponding to a thickness of a wafer to be manufactured from the ingot, and before the holding step, a wafer manufacturing step of manufacturing the wafer by peeling off a portion of the ingot as the wafer from the peel-off layers as separation initiating points. Each of the first workpiece and the second workpiece is the ingot having a peel-off surface from which the wafer has been peeled off in the wafer manufacturing step or the wafer having a peel-off surface that has been peeled off from the ingot in the wafer manufacturing step. In the surface irregularity reducing step, the peel-off surfaces of a combination of at least either an ingot and an ingot, a wafer and a wafer, or an ingot and a wafer are moved relatively to each other while in contact with each other.

In accordance with another aspect of the present invention, there is provided a surface irregularity reducing apparatus including a first holder for holding a first workpiece thereon, a second holder for holding thereon a second workpiece that is of the same material as the first workpiece held on the first holder, in facing relation to the first workpiece, and a moving mechanism for moving the first holder and the second holder relatively to each other. The moving mechanism moves the first holder and the second holder relatively to each other while the first workpiece held on the first holder and the second workpiece held on the second holder are being kept in contact with each other, thereby removing surface irregularities of a contact surface of at least either the first workpiece or the second workpiece.

Preferably, the moving mechanism includes a first moving unit for moving the first holder and the second holder relatively to each other in a direction parallel to the contact surface, a second moving unit for moving the first holder and the second holder relatively toward and away from each other in a direction transverse to the contact surface, and a pressure sensor mounted on at least either the first holder or the second holder for measuring a pressure produced when the first workpiece and the second workpiece are pressed against each other. While the first moving unit is moving the first holder and the second holder relatively to each other while the first workpiece and the second workpiece are being kept in contact with each other, the second moving unit adjusts a distance between the first holder and the second holder in order for a measured value of the pressure from the pressure sensor to fall within a desired range.

Preferably, each of the first workpiece and the second workpiece is an ingot having a peel-off surface from which a wafer has been peeled off or the wafer having a peel-off surface that has been peeled off from the ingot, and the moving mechanism moves peel-off surfaces of a combination of at least either an ingot and an ingot, a wafer and a wafer, or an ingot and a wafer relatively to each other while the peel-off surfaces are being kept in contact with each other.

According to the present invention, as surface irregularities of the workpieces of the same material are reduced by keeping them in abrasive contact with each other, one of the workpieces is prevented from being worn earlier than the other and from having its grinding power unduly reduced, and they abrade each other, efficiently reducing their surface irregularities. If the workpieces are made of a hard material and are ground by only the grinding wheel, the material consumed of the grinding wheel by grinding the workpieces tends to increase, resulting in an increased cost. According to the present invention, however, since the surface irregularities of the workpieces have been abraded and worn away by themselves before the workpieces are ground by the grinding wheel, the material consumed of the grinding wheel is smaller and is used more economically than if the surface irregularities of the workpieces are removed by only the grinding wheel. Moreover, the surface irregularities of the workpieces can efficiently be removed in a short period of time because they abrasively engage and abrade each other.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a fragmentary elevational view schematically illustrating a surface irregularity reducing apparatus according to a first embodiment of the present invention;

FIG. 2 is a flowchart of a sequence of a surface irregularity reducing method according to the first embodiment;

FIG. 3 is a side elevational view schematically illustrating a state in which a surface irregularity reducing step of the surface irregularity reducing method according to the first embodiment has just started;

FIG. 4 is a side elevational view schematically illustrating a state in which the surface irregularity reducing step of the surface irregularity reducing method according to the first embodiment is about to end;

FIG. 5 is a perspective view schematically illustrating a manner in which a first workpiece is ground in a grinding step of the surface irregularity reducing method according to the first embodiment;

FIG. 6 is a perspective view schematically illustrating a manner in which a second workpiece is ground in the grinding step of the surface irregularity reducing method according to the first embodiment;

FIG. 7 is a plan view of an ingot as an example of a first workpiece to be processed by a surface irregularity reducing apparatus and a surface irregularity reducing method according to a second embodiment of the present invention;

FIG. 8 is a side elevational view of the ingot illustrated in FIG. 7;

FIG. 9 is a perspective view of a wafer as an example of a second workpiece to be processed by the surface irregularity reducing apparatus and the surface irregularity reducing method according to the second embodiment;

FIG. 10 is a flowchart of a sequence of the surface irregularity reducing method according to the second embodiment;

FIG. 11 is a perspective view schematically illustrating a peel-off layer forming step of the surface irregularity reducing method illustrated in FIG. 10;

FIG. 12 is a side elevational view schematically illustrating the peel-off layer forming step of the surface irregularity reducing method illustrated in FIG. 10;

FIG. 13 is a perspective view schematically illustrating a wafer fabricating step of the surface irregularity reducing method illustrated in FIG. 10;

FIG. 14 is a side elevational view schematically illustrating a surface irregularity reducing step of a surface irregularity reducing method according to a third embodiment of the present invention;

FIG. 15 is a side elevational view schematically illustrating a surface irregularity reducing step of a surface irregularity reducing method according to a first modification of the second and third embodiments; and

FIG. 16 is a side elevational view schematically illustrating a surface irregularity reducing step of a surface irregularity reducing method according to a second modification of the second and third embodiments.

### DETAILED DESCRIPTION OF THE PREFERRED EMBODIMENTS

Preferred embodiments of the present invention will be described hereinbelow with reference to the accompanying drawings. The present invention is not limited to the details of the embodiments described below. The components described below cover those which could easily be anticipated by those skilled in the art and those which are essentially identical to those described above. Further, arrangements described below can be combined in appropriate manners. Various omissions, replacements, or changes of the arrangements may be made without departing from the scope of the present invention. Those components that are identical to each other are denoted by identical reference symbols throughout views.

### First Embodiment

### Surface Irregularity Reducing Apparatus:

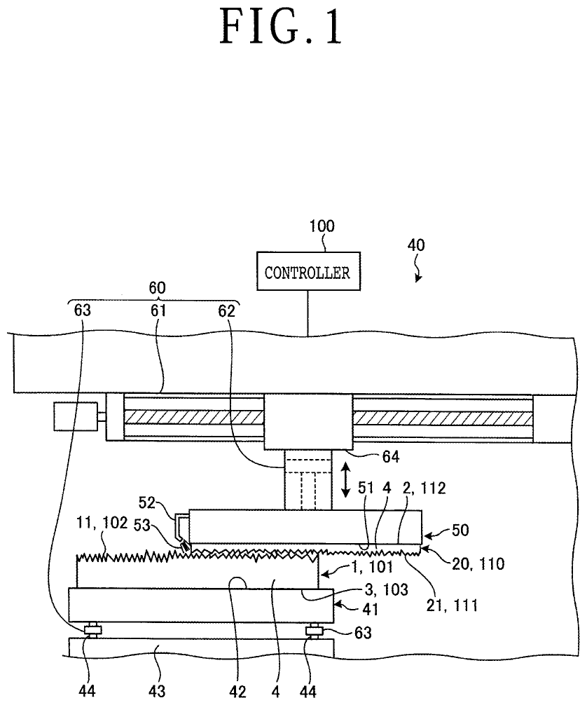

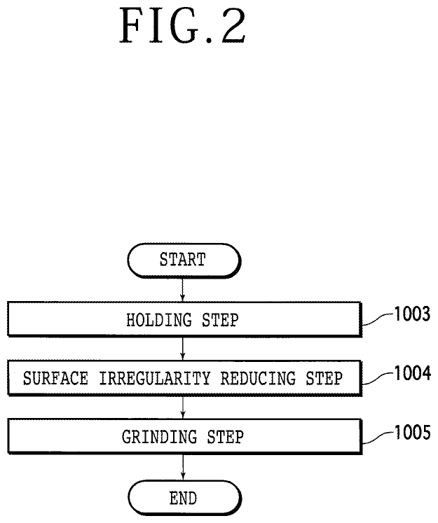

A surface irregularity reducing apparatus and a surface irregularity reducing method according to a first embodiment of the present invention will be described below with reference to the drawings. FIG. 1 schematically illustrates in fragmentary elevation the surface irregularity reducing apparatus according to the first embodiment. FIG. 2 is a flowchart of a sequence of the surface irregularity reducing method according to the first embodiment. As illustrated in FIG. 1, the surface irregularity reducing apparatus, denoted by 40, is an apparatus for reducing at least either surface irregularities of a contact surface 102 as one surface of a first workpiece 101 or surface irregularities of a contact surface 111 as one surface of a second workpiece 110. The first workpiece 101 and the second workpiece 110 are made of the same material. Typically, the first workpiece 101 is a cylindrical ingot of semiconductor material, and the second workpiece 110 is a disk-shaped wafer peeled off from the ingot. The surface irregularity reducing apparatus 40 includes a first holder 41, a second holder 50, a moving mechanism 60, and a controller 100.

The first holder 41 holds a back surface 103 of the first workpiece 101 that is opposite the contact surface 102, on a holding surface 42 thereof that lies parallel to horizontal directions. The holding surface 42 is fluidly connected to a vacuum suction source, not illustrated. When the vacuum suction source generates and applies a suction force or negative pressure to the holding surface 42, the holding surface 42 holds the back surface 103 of the first workpiece 101 under suction thereon.

The second holder 50 holds the second workpiece 110 thereon in facing relation to the contact surface 102 of the first workpiece 101 held on the first holder 41. The second holder 50 is shaped as a circular plate and has a holding surface 51 for holding the second workpiece 110 thereon to have the contact surface 111 in facing relation to the contact surface 102 of the first workpiece 101 held on the first holder 41. The holding surface 51 lies flatwise along the horizontal directions. The holding surface 51 is fluidly connected to a vacuum suction source, not illustrated. When the vacuum suction source generates and applies a suction force or negative pressure to the holding surface 51, the holding surface 51 holds a back surface 112 of the second workpiece 110 that is opposite the contact surface 111 under suction thereon. The second holder 50 can be moved by the moving mechanism 60 while holding the second workpiece 110 under suction on the holding surface 51.

A liquid supply nozzle 52 is attached to the second holder 50. The liquid supply nozzle 52 supplies a liquid 53, e.g., pure water, to a portion between the first workpiece 101 held on the first holder 41 and the second workpiece 110 held on the second holder 50.

The moving mechanism 60 moves the first holder 41 and the second holder 50 relatively to each other. The moving mechanism 60 includes a first moving unit 61, a second moving unit 62, and a plurality of pressure sensors 63.

The first moving unit 61 moves the first holder 41 and the second holder 50 relatively to each other in directions, i.e., the horizontal directions according to the first embodiment, parallel to the contact surfaces 102 and 111. The first moving unit 61 is disposed above the first holder 41. According to the first embodiment, the first moving unit 61 moves a moving table 64 that holds the second moving unit 62 in the horizontal directions. The first moving unit 61 moves the moving table 64 in the horizontal directions to thereby move the second holder 50 in unison with the second moving unit 62 in the horizontal directions between a position where the holding surface 51 of the second holder 50 vertically faces, i.e., is in vertical alignment with, the holding surface 42 of the first holder 41 and a retracted position where the holding surface 51 is retracted out of vertical alignment with the holding surface 42.

The second moving unit 62 moves the first holder 41 and the second holder 50 relatively toward and away from each other in directions, i.e., vertical directions according to the first embodiment, transverse to the contact surfaces 102 and 111. The second moving unit 62 is disposed on the moving table 64. According to the first embodiment, the second moving unit 62 moves the second holder 50 in the vertical directions to thereby move the first holder 41 and the second holder 50 relatively toward and away from each other in the directions transverse to the contact surfaces 102 and 111.

Each of the first moving unit 61 and the second moving unit 62 includes a known ball screw that is rotatable about its central axis for moving the moving table 64 horizontally or moving the second holder 50 vertically, a known electric motor for rotating the ball screw about its central axis, and a known guide rail that supports the moving table 64 thereon for horizontal movement or supports the second holder 50 thereon for vertical movement.

Each of the pressure sensors 63 is mounted on at least either the first holder 41 or the second holder 50 and measures a pressure generated when the first workpiece 101 held on the first holder 41 and the second workpiece 110 held on the second holder 50 are pressed against each other. According to the first embodiment, the pressure sensors 63 include three pressure sensors mounted on respective support posts 44 that are disposed between the first holder 41 and an installation table 43 on which the first holder 41 is installed and that support the first holder 41 thereon. According to the present invention, however, the positions where the pressure sensors 63 are provided are not limited to those according to the first embodiment insofar as they can measure information representing the pressure generated when the first workpiece 101 held on the first holder 41 and the second workpiece 110 held on the second holder 50 are pressed against each other.

According to the present invention, the pressure sensors 63 may be disposed between the second moving unit 62 and the second holder 50, or on the second holder 50 or the first holder 41. Each of the pressure sensors 63 includes a known strain gage, for example, and measures information representing the produced pressure and outputs a signal representing the measured information to the controller 100.

The controller 100 controls the components of the surface irregularity reducing apparatus 40 to reduce surface irregularities of the contact surfaces 102 and 111. The controller 100 is a computer including an arithmetic processing device that has a microprocessor such as a central processing unit (CPU), a storage device that has a memory such as a read only memory (ROM) or a random access memory (RAM), and an input/output interface device. The arithmetic processing device of the controller 100 performs arithmetic processing operations according to computer programs stored in the storage device to generate and output control signals for controlling the surface irregularity reducing apparatus 40 through the input/output interface device to the components of the surface irregularity reducing apparatus 40.

The controller 100 is electrically connected to a display unit having a liquid crystal display device for displaying states of processing operation and images and an input unit that an operator uses to register processing content information, etc. The input unit includes a touch panel incorporated in the display unit.

Surface Irregularity Reducing Method:

The surface irregularity reducing method according to the first embodiment will be described below. The surface irregularity reducing method according to the first embodiment is a method of reducing at least either surface irregularities of the contact surface 102 of the first workpiece 101 or surface irregularities of the contact surface 111 of the second workpiece 110. As illustrated in FIG. 2, the surface irregularity reducing method according to the first embodiment includes a holding step 1003, a surface irregularity reducing step 1004, and a grinding step 1005.

Holding Step:

The holding step 1003 is a step of holding the first workpiece 101 on the first holder 41 and holding the second workpiece 110 on the second holder 50. In the holding step 1003, specifically, the controller 100 of the surface irregularity reducing apparatus 40 controls the moving mechanism 60 to position the second holder 50 in the retracted position and elevate the second holder 50. In the holding step 1003, the controller 100 controls the first holder 41 and the second holder 50 to cause the holding surface 42 of the first holder 41 to hold the back surface 103 of the first workpiece 101 under suction and also to cause the holding surface 51 of the second holder 50 to hold the back surface 112 of the second workpiece 110.

Surface Irregularity Reducing Step:

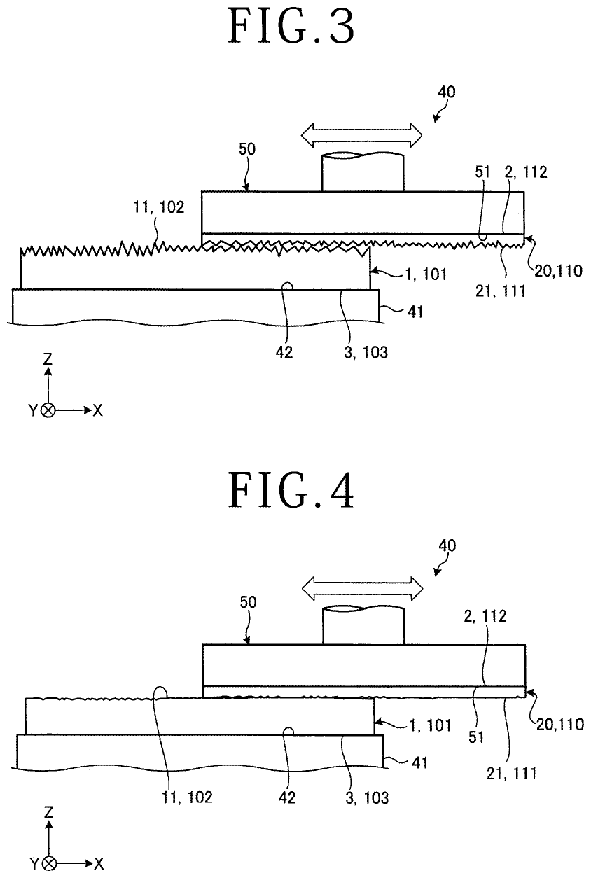

FIG. 3 schematically illustrates in side elevation a state in which the surface irregularity reducing step 1004 of the surface irregularity reducing method according to the first embodiment has just started. FIG. 4 schematically illustrates in side elevation a state in which the surface irregularity reducing step 1004 of the surface irregularity reducing method according to the first embodiment is about to end. The surface irregularity reducing step 1004 is a step of moving the first holder 41 and the second holder 50 relatively to each other while keeping the contact surface 102 of the first workpiece 101 and the contact surface 111 of the second workpiece 110 in contact with each other, thereby reducing surface irregularities of at least either the contact surface 102 of the first workpiece 101 or the contact surface 111 of the second workpiece 110. According to the first embodiment, the surface irregularity reducing step 1004 is a step of reducing surface irregularities of both the contact surface 102 of the first workpiece 101 and the contact surface 111 of the second workpiece 110.

In the surface irregularity reducing step 1004, as illustrated in FIG. 3, the controller 100 of the surface irregularity reducing apparatus 40 controls the first moving unit 61 and the second moving unit 62 to bring the contact surface 111 of the second workpiece 110 held on the second holder 50 into contact with the contact surface 102 of the first workpiece 101 held on the first holder 41. Then, while controlling the first moving unit 61 to keep the contact surfaces 102 and 111 of the first workpiece 101 and the second workpiece 110 in contact with each other, the controller 100 moves the contact surfaces 102 and 111 relatively to each other for a predetermined period of time while supplying the liquid 53 from the liquid supply nozzle 52, omitted from illustration in FIG. 3. Specifically, according to the first embodiment, in the surface irregularity reducing step 1004, the controller 100 controls the first moving unit 61 to move the second workpiece 110 horizontally relatively to the first workpiece 101.

According to the first embodiment, in the surface irregularity reducing step 1004, while the contact surface 102 of the first workpiece 101 and the contact surface 111 of the second workpiece 110 are moving relatively to each other while in contact with each other, the controller 100 controls the second moving unit 62 to adjust the distance between the first holder 41 and the second holder 50 in order for the information representing the pressures measured by the pressure sensors 63 to fall within a desired range. The desired range refers to a range exceeding a predetermined lower limit value and but falling below a predetermined upper limit value. The predetermined lower limit value refers to a value at which the surface irregularities of the contact surfaces 102 and 111 of the first workpiece 101 and the second workpiece 110 can be reduced. The predetermined upper limit value refers to a value at which at least one of the first workpiece 101 and the second workpiece 110 is broken. A reduction in surface irregularities means a reduction in surface roughness of the contact surfaces 102 and 111.

In the surface irregularity reducing step 1004, therefore, the controller 100 of the surface irregularity reducing apparatus 40 controls the second moving unit 62 to move the second holder 50 toward or away from the first holder 41 in order to cause the information representing the pressures measured by the pressure sensors 63 to fall within the desired range, thereby controlling or adjusting the pressure under which the first workpiece 101 and the second workpiece 110 are pressed against each other.

In the surface irregularity reducing step 1004, as illustrated in FIG. 4, the controller 100 controls the first moving unit 61 to move the contact surfaces 102 and 111 of the first workpiece 101 and the second workpiece 110 horizontally relatively to each other while keeping the contact surfaces 102 and 111 in contact with each other, causing the surface irregularities of the contact surfaces 102 and 111 to be abraded, worn, and gradually reduced. In the surface irregularity reducing step 1004, therefore, the surface irregularity reducing apparatus 40 reduces the surface irregularities of at least either the contact surface 102 of the first workpiece 101 or the contact surface 111 of the second workpiece 110 by controlling the first moving unit 61 to move the contact surfaces 102 and 111 relatively to each other while keeping them in contact with each other. According to the first embodiment, the surface irregularity reducing apparatus 40 reduces the surface irregularities of both the contact surface 102 of the first workpiece 101 and the contact surface 111 of the second workpiece 110. A reduction in the surface irregularities of the contact surfaces 102 and 111 means a reduction in the surface roughness, i.e., arithmetic average roughness or the like, of the contact surfaces 102 and 111.

According to the first embodiment, in the surface irregularity reducing step 1004, the controller 100 controls the second moving unit 62 in order for the information representing the pressures measured by the three pressure sensors 63, i.e., all the pressure sensors 63, to fall within the desired range.

Grinding Step:

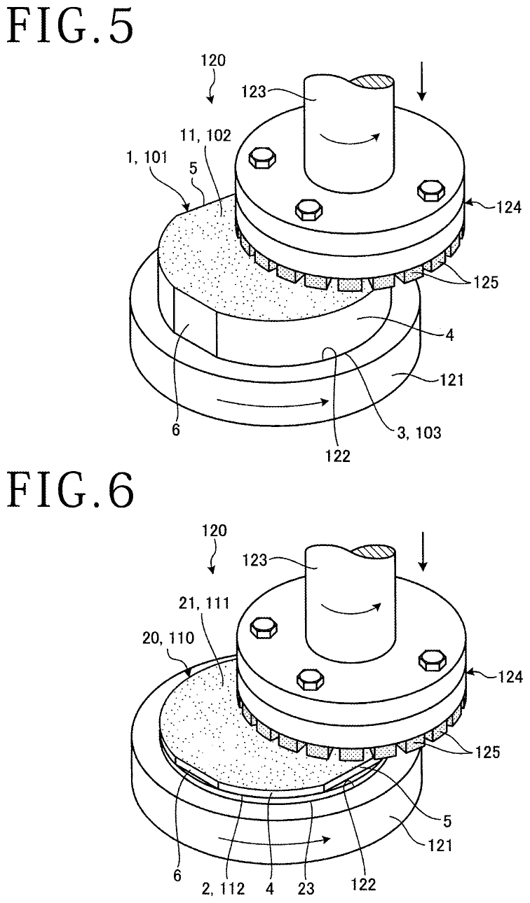

FIG. 5 schematically illustrates in perspective a manner in which the first workpiece 101 is ground in the grinding step 1005 of the surface irregularity reducing method according to the first embodiment. FIG. 6 schematically illustrates in perspective a manner in which the second workpiece 110 is ground in the grinding step 1005 of the surface irregularity reducing method according to the first embodiment. The grinding step 1005 is a step of, after the surface irregularity reducing step 1004, grinding at least either the contact surface 102 of the first workpiece 101 or the contact surface 111 of the second workpiece 110 with a grinding wheel 124. According to the first embodiment, in the grinding step 1005, both of the contact surfaces 102 and 111 of the first workpiece 101 and the second workpiece 110 are ground by the grinding wheel 124. According to the present invention, however, at least either the contact surface 102 or the contact surface 111 may be ground by the grinding wheel 124.

According to the first embodiment, in the grinding step 1005, a grinding apparatus 120 holds the back surface 103 of the first workpiece 101 under suction on a holding surface 122 of a chuck table 121. In the grinding step 1005, as illustrated in FIG. 5, the grinding apparatus 120 rotates the grinding wheel 124 about its vertical central axis with a spindle 123 and also rotates the chuck table 121 about its vertical central axis with a rotary actuator, not illustrated. While supplying a grinding liquid from a grinding liquid nozzle, not illustrated, to the contact surface 102 of the first workpiece 101, the grinding apparatus 120 brings grindstones 125 of the grinding wheel 124 into contact with the contact surface 102 of the first workpiece 101 and moves the grindstones 125 of the grinding wheel 124 progressively closer to the chuck table 121 at a predetermined feed speed, thereby causing the grindstones 125 to grind the contact surface 102 of the first workpiece 101.

In the grinding step 1005, further, the grinding apparatus 120 holds the back surface 112 of the second workpiece 110 under suction on the holding surface 122 of the chuck table 121. In the grinding step 1005, as illustrated in FIG. 6, the grinding apparatus 120 rotates the grinding wheel 124 about its vertical central axis with the spindle 123 and also rotates the chuck table 121 about its vertical central axis with the rotary actuator, not illustrated. While supplying a grinding liquid from the grinding liquid nozzle, not illustrated, to the contact surface 111 of the second workpiece 110, the grinding apparatus 120 brings the grindstones 125 of the grinding wheel 124 into contact with the contact surface 111 of the second workpiece 110 and moves the grindstones 125 of the grinding wheel 124 progressively closer to the chuck table 121 at a predetermined feed speed, thereby causing the grindstones 125 to grind the contact surface 111 of the second workpiece 110.

As described above, the surface irregularity reducing apparatus 40 and the surface irregularity reducing method according to the first embodiment reduce the surface irregularities of the contact surfaces 102 and 111 of the first workpiece 101 and the second workpiece 110 by relatively moving and abrading the contact surfaces 102 and 111 against each other while keeping the contact surfaces 102 and 111 in contact with each other. Since the contact surfaces 102 and 111 of the first workpiece 101 and the second workpiece 110 that are made of the same material are abraded against each other, one of the contact surfaces 102 and 111 is prevented from being worn earlier than the other and from having its grinding power unduly reduced, and both of the contact surfaces 102 and 111 are worn at equal rates, so that the surface irregularities of both of the contact surfaces 102 and 111 can be reduced.

Inasmuch as the surface irregularity reducing apparatus 40 and the surface irregularity reducing method according to the first embodiment relatively move and abrade the contact surfaces 102 and 111 of the first workpiece 101 and the second workpiece 110 while keeping the contact surfaces 102 and 111 in contact with each other, the surface irregularities of the contact surfaces 102 and 111 are reduced using the surface irregularities themselves that have heretofore been removed by a grinding process, so that the grindstones 125 of the grinding wheel 124 for reducing the surface irregularities are prevented from being unduly consumed and hence are economically used. Further, since the surface irregularity reducing apparatus 40 and the surface irregularity reducing method according to the first embodiment grind the first workpiece 101 and the second workpiece 110 with the grinding wheel 124 after the surface irregularities thereof have been reduced, the amount of material ground off the first and second workpieces 101 and 110 by the grinding wheel 124 and the period of time in which the first and second workpieces 101 and 110 are ground by the grinding wheel 124 are minimized, so that the grindstones 125 of the grinding wheel 124 for reducing the surface irregularities are prevented from being unduly consumed and hence are economically used.

As a consequence, the surface irregularity reducing apparatus 40 and the surface irregularity reducing method according to the first embodiment are advantageous in that they can economically reduce the surface irregularities of the contact surface 102 or 111 of at least either the first workpiece 101 or the second workpiece 110 efficiently at a reduced cost irrespectively of the first and second workpieces 101 and 110, after peeling-off of the first workpiece 101 and the second workpiece 110.

In addition, as the surface irregularity reducing apparatus 40 and the surface irregularity reducing method according to the first embodiment reduce the surface irregularities of the first and second workpieces 101 and 110 of the same material by keeping them in abrasive contact with each other, one of the workpieces 101 and 110 is prevented from being worn earlier than the other and from having its grinding power unduly reduced, and they abrade each other, efficiently reducing their surface irregularities. If the first and second workpieces 101 and 110 are made of a hard material and are ground by only the grinding wheel 124, the material consumed of the grinding wheel 124 by grinding the first and second workpieces 101 and 110 tends to increase, resulting in an increased cost. According to the present invention, however, since the surface irregularities of the first and second workpieces 101 and 110 have been abraded and worn away by themselves before the first and second workpieces 101 and 110 are ground by the grinding wheel 124, the material consumed of the grinding wheel 124 is smaller and can be used more economically than if the surface irregularities of the first and second workpieces 101 and 110 are removed by only the grinding wheel 124. Moreover, the surface irregularities of the first and second workpieces 101 and 110 can efficiently be removed in a short period of time because they abrasively engage and abrade each other.

### Second Embodiment

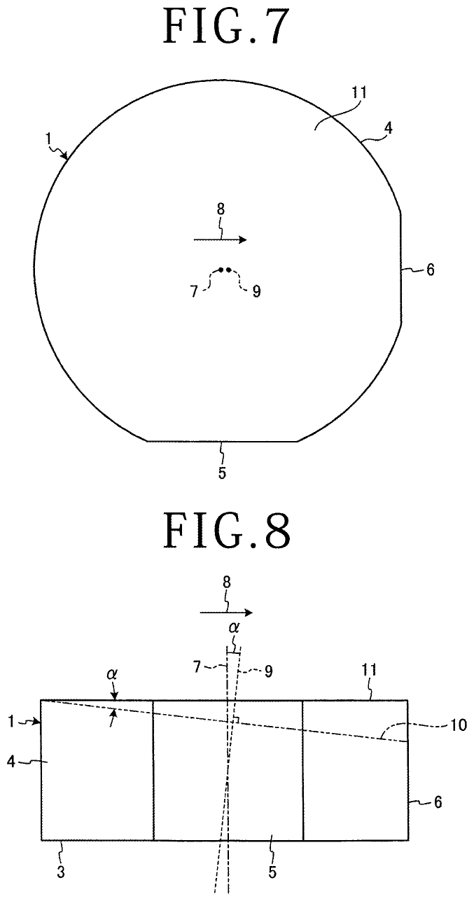

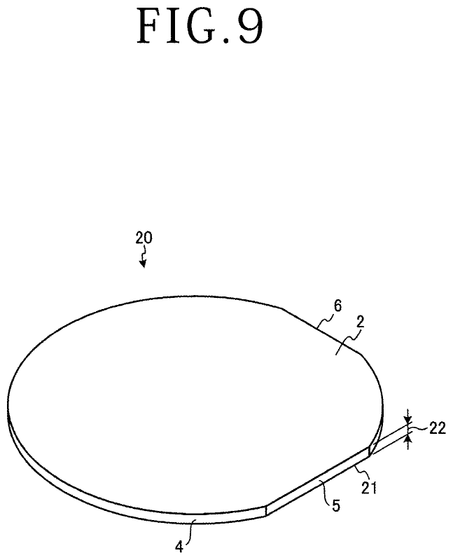

A surface irregularity reducing apparatus and a surface irregularity reducing method according to a second embodiment of the present invention will be described below with reference to the drawings. FIG. 7 illustrates in plan an ingot as an example of a first workpiece to be processed by the surface irregularity reducing apparatus and the surface irregularity reducing method according to the second embodiment. FIG. 8 illustrates in side elevation the ingot illustrated in FIG. 7. FIG. 9 illustrates in perspective a wafer as an example of a second workpiece to be processed by the surface irregularity reducing apparatus and the surface irregularity reducing method according to the second embodiment. Those parts illustrated in FIGS. 7 through 9 that are identical to those illustrated according to the first embodiment are denoted by identical reference symbols and will be omitted from detailed description.

Ingot and Wafer:

The surface irregularity reducing method according to the second embodiment is a method of reducing the surface irregularities of at least either the ingot, denoted by 1, as the first workpiece illustrated in FIGS. 7 and 8 or the wafer, denoted by 20, as the second workpiece illustrated in FIG. 9.

The ingot 1 illustrated in FIG. 7, which is to be processed by the surface irregularity reducing method according to the second embodiment, is of a cylindrical shape as a whole and is made of silicon carbide (SiC). According to the second embodiment, the ingot 1 is a hexagonal monocrystalline SiC ingot. According to the present invention, however, the ingot 1 may be made of germanium (Ge), gallium arsenide (GaAs), or silicon (Si).

As illustrated in FIGS. 7 and 8, the ingot 1 has a circular peel-off surface 11, which corresponds to a contact surface, a circular second surface 3, which corresponds to a back surface, that is opposite the peel-off surface 11, and a peripheral surface 4 contiguous to an outer edge of the peel-off surface 11 and an outer edge of the second surface 3. The ingot 1 also has on the peripheral surface 4 a straight first orientation flat 5 indicating a crystal orientation of the ingot 1 and a straight second orientation flat 6 extending perpendicularly to the first orientation flat 5. The first orientation flat 5 is longer than the second orientation flat 6.

After the peel-off surface 11 of the ingot 1 has been roughly ground and then finishingly ground by a grinding apparatus, the peel-off surface 11 is polished by a polishing apparatus into a mirror surface that will serve as a first surface 2 (see FIG. 9) of a wafer 20 to be separated from the ingot 1. The ingot 1 includes a c-axis 9 inclined to a line 7 normal to the peel-off surface 11 through an off-angle α in an inclined direction 8 toward the second orientation flat 6, and a c-plane 10 perpendicular to the c-axis 9. The c-plane 10 is inclined to the peel-off surface 11 through the off-angle α. The inclined direction 8 in which the c-axis 9 is inclined to the line 7 extends perpendicularly to a direction in which the second orientation flat 6 extends and parallel to the first orientation flat 5. The c-plane 10 is established countlessly at the molecular level in the ingot 1. According to the second embodiment, the off-angle α is set to 1°, 4°, or 6°. According to the present invention, however, the ingot 1 may be fabricated with the off-angle α freely set in a range of 1° to 6°, for example.

A portion of the ingot 1 that includes the peel-off surface 11 and that extends generally parallel to the peel-off surface 11 is peeled off, and is made into the wafer 20 illustrated in FIG. 9. After the portion of the ingot 1 has been peeled off, the remaining ingot 1 has its thickness reduced. The remaining ingot 1 has a new peel-off surface 11 from which the wafer 20 has been peeled-off as the second workpiece and the second surface 3 opposite the peel-off surface 11. Then, the peel-off surface 11 is ground and polished into a mirror surface that will serve as a first surface 2 of a next wafer 20 to be separated from the ingot 1. Thereafter, the next wafer 20 is peeled off from the ingot 1. The ingot 1 that has the peel-off surface 11 ground and polished into a mirror surface will hereinafter be denoted by 1-1 (see FIG. 11).

The wafer 20 illustrated in FIG. 9 has been produced from the ingot 1 and includes the first surface 2. The wafer 20 has, in addition to the first surface 2, a peel-off surface 21, which corresponds to a contact surface, opposite the first surface 2 and peeled off from the ingot 1. Therefore, the wafer 20 is made of the same material as the ingot 1. After the peel-off surface 21 of the ingot 1 has been roughly ground and then finishingly ground by the grinding apparatus, the peel-off surface 21 is polished into a mirror surface by the polishing apparatus. Then, a plurality of devices are constructed in respective areas demarcated in a grid pattern by a plurality of projected dicing lines established on the polished peel-off surface 21.

According to the second embodiment, the devices include metal-oxide-semiconductor field-effect transistors (MOSFETs), microelectromechanical systems (MEMS), or Schottky barrier diodes (SBDs). According to the present invention, however, the devices are not limited to MOSFETs, MEMS, or SBDs. Those parts of the wafer 20 that are identical to those of the ingot 1 or 1-1 are denoted by identical reference symbols and will be omitted from detailed description.

Surface Irregularity Reducing Method:

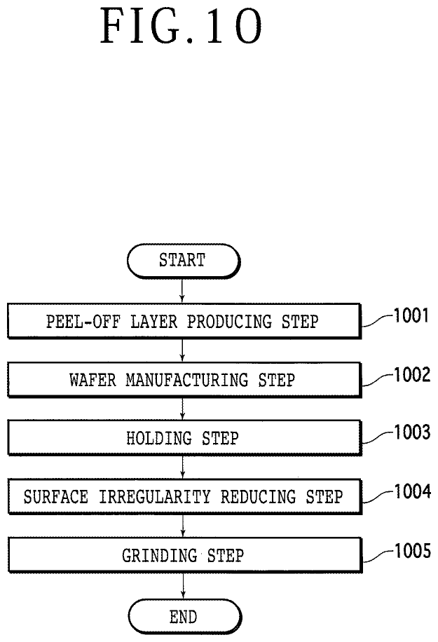

FIG. 10 is a flowchart of a sequence of the surface irregularity reducing method according to the second embodiment. The surface irregularity reducing method according to the second embodiment is a method of reducing at least either surface irregularities of the peel-off surface 11 of the ingot 1 or surface irregularities of the peel-off surface 21 of the wafer 20. The surface irregularity reducing method according to the second embodiment is also a method of manufacturing a wafer 20 by peeling off a portion as the wafer 20 from the ingot 1-1 where the peel-off surface 11 has been processed into the first surface 2. As illustrated in FIG. 10, the surface irregularity reducing method according to the second embodiment includes a peel-off layer producing step 1001, a wafer manufacturing step 1002, a holding step 1003, a surface irregularity reducing step 1004, and a grinding step 1005.

Peel-Off Layer Producing Step:

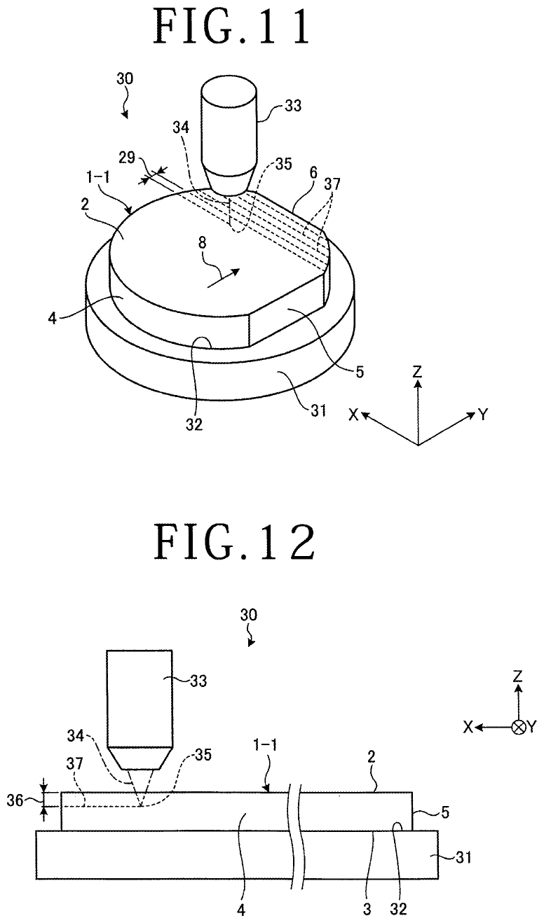

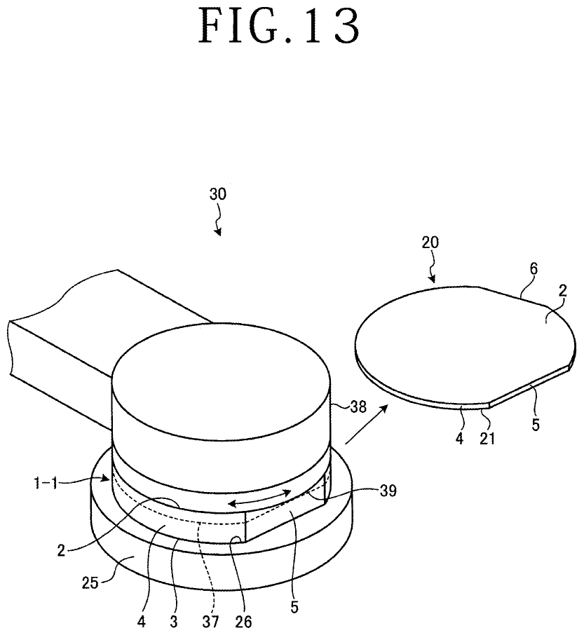

FIG. 11 schematically illustrates in perspective the peel-off layer producing step 1001 of the surface irregularity reducing method illustrated in FIG. 10. FIG. 12 schematically illustrates in side elevation the peel-off layer producing step 1001 of the surface irregularity reducing method illustrated in FIG. 10. The peel-off layer producing step 1001 is a step of, prior to the holding step 1003, applying a pulsed laser beam 34 (see FIG. 11) having a wavelength transmittable through the ingot 1-1 having the first surface 2 to the ingot 1-1 while positioning a focused spot 35 of the pulsed laser beam 34 in the ingot 1-1 at a depth 36 (see FIG. 12) corresponding to a thickness 22 (see FIG. 9) of the wafer 20 to be manufactured from the first surface 2, thereby producing a peel-off layer 37 in the ingot 1-1 that extends parallel to the first surface 2 and the second surface 3 of the ingot 1-1. The wafer 20 is to be peeled off from the ingot 1-1 along the peel-off layer 37.

In the peel-off layer producing step 1001, specifically, a wafer manufacturing apparatus 30 holds the second surface 3 of the ingot 1-1 under suction on a holding surface 32 of a holding table 31. Then, the wafer manufacturing apparatus 30 controls a laser beam applying unit 33 to position the focused spot 35 of the pulsed laser beam 34 whose wavelength is transmittable through the ingot 1-1 in the ingot 1-1 at the depth 36 corresponding to the thickness 22 of the wafer 20 to be manufactured from the first surface 2, and to apply the pulsed laser beam 34 to the ingot 1-1 while relatively moving the laser beam applying unit 33 and the holding table 31 in an X-axis direction parallel to the horizontal directions from a position near the peripheral surface 4 adjacent to one end of the second orientation flat 6. According to the second embodiment, the X-axis direction extends parallel to the second orientation flat 6.

When the pulsed laser beam 34 is applied to the ingot 1-1, since the pulsed laser beam 34 has a wavelength transmittable through the ingot 1-1, it produces a modified region in the ingot 1-1 at the depth 36 from the first surface 2 along the X-axis direction and cracks extending from the modified region along the c-plane 10. Specifically, molecules of SiC in the ingot 1-1 are separated into molecules of Si and molecules of carbon (C) by a pulse of the laser beam 34, and a next pulse of the laser beam 34 is absorbed by the previously produced molecules of C. In the ingot 1-1, molecules of SiC are separated into molecules of Si and molecules of C in a chain reaction by successively applied pulses of the laser beam 34, developing a modified region in the ingot 1-1 and cracks extending from the modified region. In this manner, when the pulsed laser beam 34 whose wavelength is transmittable through the ingot 1-1 is applied to the ingot 1-1, a peel-off layer 37 that includes the modified region extending along the X-axis direction and the cracks extending from the modified region along the c-plane 10 is created in the ingot 1-1. According to the second embodiment, as illustrated in FIG. 11, the peel-off layer 37 is created adjacent to the second orientation flat 6 parallel thereto along the entire length thereof from one end thereof to the other.

The modified region refers to a region where physical properties such as density, refractive index, mechanical strength, etc., are different from those in surrounding regions, and includes, for example, a melted region, a cracked region, a dielectric-breakdown region, a varied-refractive-index region, and/or a region where these regions are mixed together. The modified region is lower in mechanical strength, etc., than other regions in the ingot 1-1.

In the peel-off layer producing step 1001, when the wafer manufacturing apparatus 30 has created the peel-off layer 37 in the ingot 1-1 along the entire length of the second orientation flat 6, the wafer manufacturing apparatus 30 controls the laser beam applying unit 33 to stop applying the pulsed laser beam 34, and then relatively moves, i.e., indexing-feeds, the laser beam applying unit 33 and the holding table 31 horizontally along a Y-axis direction perpendicular to the X-axis direction for a predetermined distance 29 (see FIG. 11). After the wafer manufacturing apparatus 30 has indexing-fed the laser beam applying unit 33 and the holding table 31, the wafer manufacturing apparatus 30 positions again the focused spot 35 of the pulsed laser beam 34 at the depth 36 in the ingot 1-1, and applies the pulsed laser beam 34 to the ingot 1-1 while relatively moving the laser beam applying unit 33 and the holding table 31 in the X-axis direction from a position near the peripheral surface 4 adjacent to one end of the previously created peel-off layer 37, thereby creating a next peel-off layer 37 in the ingot 1-1 along the X-axis direction parallel to the previously created peel-off layer 37.

In the peel-off layer producing step 1001, then, the wafer manufacturing apparatus 30 alternately applies the laser beam 34 to the ingot 1-1 while relatively moving the laser beam applying unit 33 and the holding table 31 along the X-axis direction and indexing-feeds the laser beam applying unit 33 and the holding table 31 along the Y-axis direction, repeatedly until peel-off layers 37 are created throughout the ingot 1-1 below the first surface 2. In this manner, the peel-off layers 37 are created throughout the ingot 1-1 below the first surface 2.

Wafer Manufacturing Step:

FIG. 13 schematically illustrates in perspective the wafer manufacturing step 1002 of the surface irregularity reducing method illustrated in FIG. 10. The wafer manufacturing step 1002 is a step of, after the peel-off layer producing step 1001, manufacturing a wafer 20 by peeling off a portion of the ingot 1-1 from the peel-off layers 37 as separation initiating points.

In the wafer manufacturing step 1002, specifically, the wafer manufacturing apparatus 30 holds the second surface 3 of the ingot 1-1 under suction on a holding surface 26 of a second holding table 25. Then, the wafer manufacturing apparatus 30 retracts the laser beam applying unit 33 away from above the second surface 3 of the ingot 1-1 held on the second holding table 25 with the peel-off layers 37 created in the ingot 1-1. As illustrated in FIG. 13, the wafer manufacturing apparatus 30 then holds the first surface 2 of the ingot 1-1 under suction on an attraction surface 39 provided by a lower surface of a holder 38. Thereafter, while supplying a liquid from liquid supply means, not illustrated, to the peel-off layers 37, the wafer manufacturing apparatus 30 applies alternating-current (AC) power to an ultrasonic vibrator, not illustrated, housed in the holder 38, for a predetermined period of time, enabling the ultrasonic vibrator to impose ultrasonic vibrations to the holder 38.

When the ultrasonic vibrator imposes ultrasonic vibrations to the holder 38, the holder 38 transmits and applies the ultrasonic vibrations to the first surface 2 of the ingot 1-1. The applied ultrasonic vibrations stimulate the peel-off layers 37, dividing a portion of the ingot 1-1 from the peel-off layers 37 as a wafer 20 manufactured from the ingot 1-1.

After the wafer manufacturing apparatus 30 has applied AC power to the ultrasonic vibrator in the holder 38 for the predetermined period of time to enable the ultrasonic vibrator to impose ultrasonic vibrations to the holder 38, dividing the wafer 20 from the ingot 1-1, the wafer manufacturing apparatus 30 stops applying AC power to the ultrasonic vibrator and retracts the holder 38 away from above the second holding table 25, peeling off the wafer 20 from the ingot 1-1. According to the present invention, as long as the wafer 20 can be peeled off from the ingot 1-1 from the peel-off layers 37, ultrasonic vibrations may be applied to the ingot 1-1 while the ingot 1-1 is being kept in a water tank, for example. Alternatively, the wafer 20 may be peeled off from the ingot 1-1 without ultrasonic vibrations applied thereto, or may be peeled off from the ingot 1-1 according to any of various processes other than the processes according to the second embodiment.

When the portion of the ingot 1-1 near the first surface 2 has been peeled-off as the wafer 20 from the peel-off layers 37 as described above, the remainder of the ingot 1-1 is available as an ingot 1 having a peel-off surface 11, which corresponds to a contact surface, and the wafer 20 has a peel-off surface 21, which corresponds to a contact surface. The peel-off surface 11 of the ingot 1 is a surface of the ingot 1-1 from which the wafer 20 has been peeled off in the wafer manufacturing step 1002. The peel-off surface 21 of the wafer 20 is a surface peeled off from the ingot 1-1 in the wafer manufacturing step 1002. Since the peel-off surfaces 11 and 21 are separated from the peel-off layers 37, they have been part of the peel-off layers 37 in the ingot 1-1 and have surface irregularities.

Holding Step:

The holding step 1003 is a step of holding the ingot 1 from which the wafer 20 has been peeled off on the first holder 41 and holding the wafer 20 peeled off from the ingot 1 on the second holder 50. In the holding step 1003, specifically, the controller 100 of the surface irregularity reducing apparatus 40 controls the moving mechanism 60 to position the second holder 50 in the retracted position and elevate the second holder 50. In the holding step 1003, the controller 100 controls the first holder 41 and the second holder 50 to cause the holding surface 42 of the first holder 41 to hold the second surface 3 of the ingot 1 under suction and to cause the holding surface 51 of the second holder 50 to hold the first surface 2 of the wafer 20 under suction. According to the second embodiment, the ingot 1 as a first workpiece is the ingot from which the wafer 20 has been peeled off in the wafer manufacturing step 1002, and the wafer 20 as a second workpiece is the wafer manufactured in the wafer manufacturing step 1002.

Surface Irregularity Reducing Step:

The surface irregularity reducing step 1004 is a step of moving the first holder 41 and the second holder 50 relatively to each other while keeping the peel-off surface 11 of the ingot 1 and the peel-off surface 21 of the wafer 20 peeled off from the ingot 1 in contact with each other, thereby reducing surface irregularities of at least either the peel-off surface 11 of the ingot 1 or the peel-off surface 21 of the wafer 20. According to the second embodiment, the surface irregularity reducing step 1004 is a step of reducing surface irregularities of both the peel-off surface 11 of the ingot 1 and the peel-off surface 21 of the wafer 20.

In the surface irregularity reducing step 1004, as illustrated in FIG. 3, the controller 100 of the surface irregularity reducing apparatus 40 controls the first moving unit 61 and the second moving unit 62 to bring the peel-off surface 21 of the wafer 20 held on the second holder 50 into contact with the peel-off surface 11 of the ingot 1 held on the first holder 41. Then, while controlling the first moving unit 61 to keep the peel-off surfaces 11 and 21 of the ingot 1 and the wafer 20 in contact with each other, the controller 100 moves the peel-off surfaces 11 and 21 relatively to each other for a predetermined period of time while supplying the liquid 53 from the liquid supply nozzle 52, omitted from illustration in FIG. 3. Specifically, according to the second embodiment, in the surface irregularity reducing step 1004, the controller 100 controls the first moving unit 61 to move the wafer 20 horizontally relatively to the ingot 1.

According to the second embodiment, in the surface irregularity reducing step 1004, while the peel-off surface 11 of the ingot 1 and the peel-off surface 21 of the wafer 20 are moving relatively to each other while in contact with each other, the controller 100 controls the second moving unit 62 to adjust the distance between the first holder 41 and the second holder 50 in order for the information representing the pressures measured by the pressure sensors 63 to fall within a desired range. The desired range refers to a range exceeding a predetermined lower limit value but falling below a predetermined upper limit value. The predetermined lower limit value refers to a value at which the surface irregularities of the peel-off surfaces 11 and 21 of the ingot 1 and the wafer 20 can be reduced. The predetermined upper limit value refers to a value at which at least one of the wafer 20 and the ingot 1 is broken. A reduction in surface irregularities means a reduction in the surface roughness of the peel-off surfaces 11 and 21.

In the surface irregularity reducing step 1004, therefore, the controller 100 of the surface irregularity reducing apparatus 40 controls the second moving unit 62 to move the second holder 50 toward or away from the first holder 41 in order to cause the information representing the pressures measured by the pressure sensors 63 to fall within the desired range, thereby controlling or adjusting the pressure under which the ingot 1 and the wafer 20 are pressed against each other.

In the surface irregularity reducing step 1004, as illustrated in FIG. 4, the controller 100 controls the first moving unit 61 to move the peel-off surfaces 11 and 21 of the ingot 1 and the wafer 20 horizontally relatively to each other while keeping the peel-off surfaces 11 and 21 in contact with each other, causing the surface irregularities of the peel-off surfaces 11 and 21 to be abraded, worn, and gradually reduced. In the surface irregularity reducing step 1004, therefore, the surface irregularity reducing apparatus 40 reduces the surface irregularities of at least either the peel-off surface 11 of the ingot 1 or the peel-off surface 21 of the wafer 20 by controlling the first moving unit 61 to move the peel-off surfaces 11 and 21 relatively to each other while keeping them in contact with each other. According to the second embodiment, the surface irregularity reducing apparatus 40 reduces the surface irregularities of both the peel-off surface 11 of the ingot 1 and the peel-off surface 21 of the wafer 20. A reduction in the surface irregularities of the peel-off surfaces 11 and 21 means a reduction in the surface roughness, i.e., arithmetic average roughness or the like, of the peel-off surfaces 11 and 21.

According to the second embodiment, in the surface irregularity reducing step 1004, the controller 100 controls the second moving unit 62 in order for the information representing the pressures measured by the three pressure sensors 63, i.e., all the pressure sensors 63, to fall within the desired range.

Grinding Step:

The grinding step 1005 is a step of, after the surface irregularity reducing step 1004, grinding at least either the peel-off surface 11 of the ingot 1 or the peel-off surface 21 of the wafer 20 with the grinding wheel 124. According to the second embodiment, in the grinding step 1005, both of the peel-off surfaces 11 and 21 of the ingot 1 and the wafer 20 are ground by the grinding wheel 124. According to the present invention, however, at least either the peel-off surface 11 or the peel-off surface 21 may be ground by the grinding wheel 124.

According to the second embodiment, in the grinding step 1005, the grinding apparatus 120 holds the second surface 3 of the ingot 1 under suction on the holding surface 122 of the chuck table 121. In the grinding step 1005, as illustrated in FIG. 5, the grinding apparatus 120 rotates the grinding wheel 124 about its vertical central axis with the spindle 123 and also rotates the chuck table 121 about its vertical central axis with the rotary actuator, not illustrated. While supplying the grinding liquid from the grinding liquid nozzle, not illustrated, to the peel-off surface 11 of the ingot 1, the grinding apparatus 120 brings the grindstones 125 of the grinding wheel 124 into contact with the peel-off surface 11 of the ingot 1 and moves the grindstones 125 of the grinding wheel 124 progressively closer to the chuck table 121 at a predetermined feed speed, thereby causing the grindstones 125 to grind the peel-off surface 11 of the ingot 1.

In the grinding step 1005, further, a surface protection tape 23 (see FIG. 6) is affixed to the first surface 2 of the wafer 20, and the grinding apparatus 120 holds the first surface 2 of the wafer 20 under suction on the holding surface 122 of the chuck table 121 with the surface protection tape 23 interposed therebetween. As illustrated in FIG. 6, specifically, the grinding apparatus 120 rotates the grinding wheel 124 about its vertical central axis with the spindle 123 and also rotates the chuck table 121 about its vertical central axis with the rotary actuator, not illustrated. While supplying the grinding liquid from the grinding liquid nozzle, not illustrated, to the peel-off surface 21 of the wafer 20, the grinding apparatus 120 brings the grindstones 125 of the grinding wheel 124 into contact with the peel-off surface 21 of the wafer 20 and moves the grindstones 125 of the grinding wheel 124 progressively closer to the chuck table 121 at a predetermined feed speed, thereby causing the grindstones 125 to grind the peel-off surface 21 of the wafer 20.

Thereafter, the peel-off surface 11 of the ingot 1 is finishingly ground and polished into the first surface 2. Then, a portion of the ingot 1-1 near the first surface 2 thereof is peeled off as a wafer 20. In this manner, the ingot 1 becomes thinner as more wafers 20 are peeled off therefrom. Peel-off layers 37 are created in the ingot 1 and portions of the ingot 1 are peeled off as wafers 20 until the ingot 1 reaches a predetermined thickness. Each of the wafers 20 that have been peeled off has its peel-off surface 21 finishingly ground and polished, and devices are constructed on the peel-off surface 21 thus finishingly ground and polished.

The surface irregularity reducing apparatus 40 and the surface irregularity reducing method according to the second embodiment reduce the surface irregularities of the peel-off surfaces 11 and 21 of the ingot 1 and the wafer 20 by relatively moving and abrading the peel-off surfaces 11 and 21 against each other while keeping the peel-off surfaces 11 and 21 in contact with each other. Since the peel-off surfaces 11 and 21 of the ingot 1 and the wafer 20 that are made of the same material are abraded against each other in this manner, one of the peel-off surfaces 11 and 21 is prevented from being worn earlier than the other and from having its grinding power unduly reduced, and both of the peel-off surfaces 11 and 21 are worn at equal rates, so that the surface irregularities of both of the peel-off surfaces 11 and 21 can be reduced.

Inasmuch as the surface irregularity reducing apparatus 40 and the surface irregularity reducing method according to the second embodiment relatively move and abrade the peel-off surfaces 11 and 21 of the ingot 1 and the wafer 20 while keeping the peel-off surfaces 11 and 21 in contact with each other, the surface irregularities of the peel-off surfaces 11 and 21 are reduced using the surface irregularities themselves that have heretofore been removed by a grinding process, so that the grindstones 125 of the grinding wheel 124 for reducing the surface irregularities are prevented from being unduly consumed and hence are economically used. Further, since the surface irregularity reducing apparatus 40 and the surface irregularity reducing method according to the second embodiment grind the ingot 1 and the wafer 20 with the grinding wheel 124 after the surface irregularities thereof have been reduced, the amount of material ground off the ingot 1 and the wafer 20 by the grinding wheel 124 and the period of time in which the ingot 1 and the wafer 20 are ground by the grinding wheel 124 are minimized, so that the grindstones 125 of the grinding wheel 124 for reducing the surface irregularities are prevented from being unduly consumed and hence are economically used.

As a consequence, the surface irregularity reducing apparatus 40 and the surface irregularity reducing method according to the second embodiment are advantageous in that they can economically reduce the surface irregularities of at least either the peel-off surface 11 or 21 of the ingot 1 or the wafer 20, after the wafer 20 has been peeled off from the ingot 1.

In particular, as the ingot 1 and the wafer 20 are made of SiC that is harder than Si or the like, the surface irregularity reducing apparatus 40 and the surface irregularity reducing method according to the second embodiment are more effective to prevent the grindstones 125 of the grinding wheel 124 from being unduly consumed, thereby making it possible to economically reduce the surface irregularities of the peel-off surfaces 11 and 21.

In addition, as the surface irregularity reducing apparatus 40 and the surface irregularity reducing method according to the second embodiment reduce the surface irregularities of the ingot 1 and the wafer 20 of the same material by keeping them in abrasive contact with each other, one of the ingot 1 and the wafer 20 is prevented from being worn earlier than the other and from having its grinding power unduly reduced, and they abrade each other, efficiently reducing their surface irregularities. If the ingot 1 and the wafer 20 are made of a hard material and are ground by only the grinding wheel 124, the material consumed of the grinding wheel 124 by grinding the ingot 1 and the wafer 20 tends to increase, resulting in an increased cost. According to the present invention, however, since the surface irregularities of the ingot 1 and the wafer 20 of the same material have been abraded and worn away by themselves before the ingot 1 and the wafer 20 are ground by the grinding wheel 124, the material consumed of the grinding wheel 124 is smaller and can be used more economically than if the surface irregularities of the ingot 1 and the wafer 20 are removed by only the grinding wheel 124. Moreover, the surface irregularities of the ingot 1 and the wafer 20 can efficiently be removed in a short period of time because they abrasively engage and abrade each other.

According to the second embodiment, the holding table 31 used in the peel-off layer producing step 1001, the second holding table 25 used in the wafer manufacturing step 1002, and the first holder 41 used in the surface irregularity reducing step 1004 are different from each other. The holder 38 used in the wafer manufacturing step 1002 and the second holder 50 are different from each other. According to the present invention, however, the second holding table 25 used to hold the ingot 1 in the wafer manufacturing step 1002 may double as the first holder 41 in the surface irregularity reducing step 1004, and the holder 38 used to hold the wafer 20 peeled off in the wafer manufacturing step 1002 may double as the second holder 50 in the surface irregularity reducing step 1004. These modifications are effective in reducing the size of the apparatus used in the surface irregularity reducing method according to the second embodiment.

### Third Embodiment

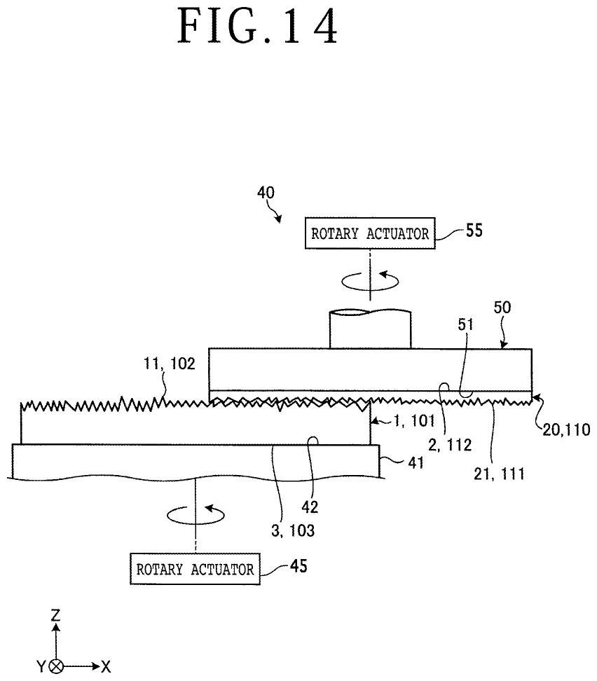

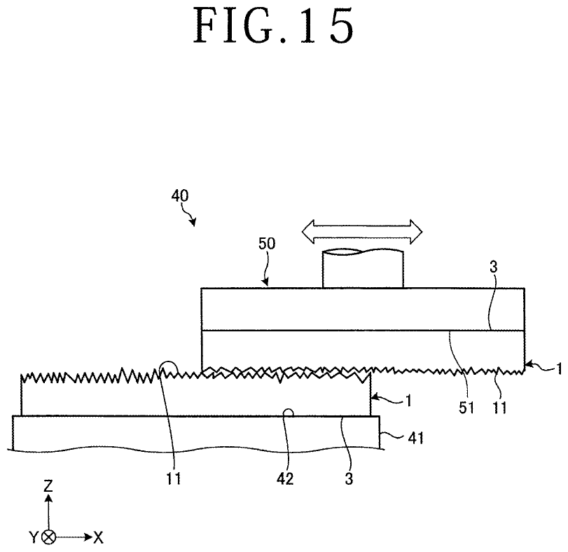

A surface irregularity reducing apparatus and a surface irregularity reducing method according to a third embodiment of the present invention will be described below with reference to the drawings. FIG. 14 schematically illustrates in side elevation a surface irregularity reducing step of the surface irregularity reducing method according to the third embodiment. Those parts illustrated in FIG. 14 that are identical to those illustrated according to the first and second embodiments are denoted by identical reference symbols and will be omitted from detailed description.

The surface irregularity reducing apparatus, denoted by 40 in FIG. 14, according to the third embodiment is similar to the surface irregularity reducing apparatus 40 according to the first and second embodiments except that it includes a rotary actuator 45 for rotating the first holder 41 about its vertical central axis and a rotary actuator 55 for rotating the second holder 50 about its vertical central axis.

In the surface irregularity reducing step 1004 of the surface irregularity reducing method according to the third embodiment, the controller 100 of the surface irregularity reducing apparatus 40 controls the first moving unit 61 and the second moving unit 62 to bring the contact surface 111 of the second workpiece 110 held on the second holder 50 or the peel-off surface 21 of the wafer 20 held on the second holder 50 into contact with the contact surface 102 of the first workpiece 101 held on the first holder 41 or the peel-off surface 11 of the ingot 1 held on the first holder 41. Then, as illustrated in FIG. 14, the controller 100 controls the rotary actuators 45 and 55 to rotate the first holder 41 and the second holder 50 about their vertical central axes for a predetermined period of time while keeping the contact surfaces 102 and 111 of the first workpiece 101 and the second workpiece 110 or the peel-off surfaces 11 and 21 of the ingot 1 and the wafer 20 in contact with each other and also while supplying the liquid 53 from the liquid supply nozzle 52, omitted from illustration in FIG. 14, thereby moving the first holder 41 and the second holder 50 relatively to each other for the predetermined period of time.

According to the third embodiment, as with the first embodiment, in the surface irregularity reducing step 1004, the controller 100 controls the second moving unit 62 to adjust the distance between the first holder 41 and the second holder 50 in order for the information representing the pressures measured by the pressure sensors 63 to fall within the desired range, and also controls the rotary actuators 45 and 55 to rotate the first holder 41 and the second holder 50 about their vertical central axes.

The surface irregularity reducing apparatus 40 and the surface irregularity reducing method according to the third embodiment are advantageous in that they can reduce the surface irregularities of the peel-off surfaces 11 and 21 of the ingot 1 and the wafer 20 as the contact surfaces 102 and 111 of the first workpiece 101 and the second workpiece 110 or the peel-off surfaces 11 and 21 of the ingot 1 and the wafer 20 are relatively moved and abraded against each other while in contact with each other.

Modifications:

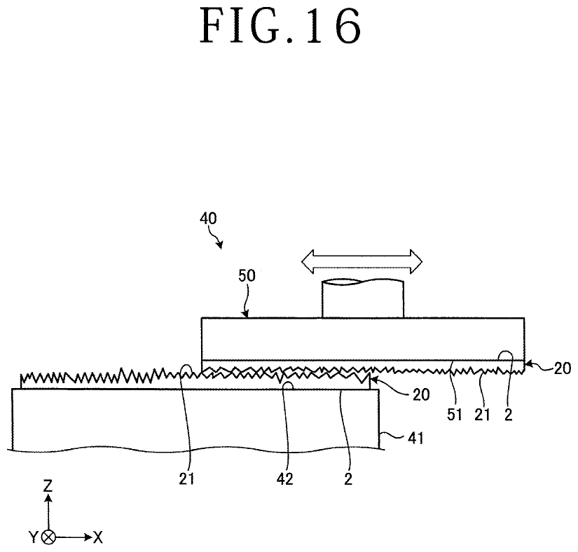

Modifications of the surface irregularity reducing apparatuses and the surface irregularity reducing methods according to the second and third embodiments will be described below with reference to the drawings. FIG. 15 schematically illustrates in side elevation a surface irregularity reducing step of a surface irregularity reducing method according to a first modification of the second and third embodiments. FIG. 16 schematically illustrates in side elevation a surface irregularity reducing step of a surface irregularity reducing method according to a second modification of the second and third embodiments. Those parts illustrated in FIGS. 15 and 16 that are identical to those illustrated according to the first embodiment are denoted by identical reference symbols and will be omitted from detailed description.

In the surface irregularity reducing method according to the first modification, in the holding step 1003, the surface irregularity reducing apparatus 40 holds the second surface 3 of an ingot 1 under suction on the holding surface 42 of the first holder 41 and holds the second surface 3 of an ingot 1 under suction on the holding surface 51 of the second holder 50. Then, as illustrated in FIG. 15, in the surface irregularity reducing step 1004, while keeping the peel-off surfaces 11 of these ingots 1 in contact with each other, the surface irregularity reducing apparatus 40 moves the second holder 50 horizontally, thereby moving the first holder 41 and the second holder 50 relatively to each other.

In the surface irregularity reducing method according to the second modification, in the holding step 1003, the surface irregularity reducing apparatus 40 holds the first surface 2 of a wafer 20 under suction on the holding surface 42 of the first holder 41 and holds the first surface 2 of a wafer 20 under suction on the holding surface 51 of the second holder 50. Then, as illustrated in FIG. 16, in the surface irregularity reducing step 1004, while keeping the peel-off surfaces 21 of these wafers 20 in contact with each other, the surface irregularity reducing apparatus 40 moves the second holder 50 horizontally, thereby moving the first holder 41 and the second holder 50 relatively to each other.

According to the first and second modifications, in the surface irregularity reducing step 1004, as with the third embodiment, the rotary actuators 45 and 55 may rotate the first holder 41 and the second holder 50 about their vertical central axes. According to the first and second modifications, in the surface irregularity reducing step 1004, as with the second and third embodiments, the controller 100 of the surface irregularity reducing apparatus 40 controls the second moving unit 62 to move the first holder 41 and the second holder 50 relatively to each other while adjusting the distance therebetween in order to cause the information representing the pressures measured by the pressure sensors 63 to fall within the desired range.

According to the first modification, each of the first workpiece and the second workpiece is the ingot 1. According to the second modification, each of the first workpiece and the second workpiece is the wafer 20.

In the surface irregularity reducing method according to the present invention, each of the first workpiece 101 and the second workpiece 110 is either the ingot 1 having the peel-off surface 11 from which the wafer 20 has been peeled off in the wafer manufacturing step 1002 or the wafer 20 having the peel-off surface 21 that has been peeled off from the ingot 1-1 in the wafer manufacturing step 1002. In the surface irregularity reducing method according to the present invention, the surface irregularity reducing step 1004 may be carried out such that, while the peel-off surface 11 or 21 of a combination of at least either the ingot 1 and the ingot 1, the wafer 20 and the wafer 20, or the ingot 1 and the wafer 20 are being held in contact with each other, they are moved relatively to each other, and the pressure under which the ingot 1 and the ingot 1, the wafer 20 and the wafer 20, or the ingot 1 and the wafer 20 are pressed against each other is controlled.

The surface irregularity reducing apparatus 40 and the surface irregularity reducing methods according to the first and second modifications are advantageous in that they can reduce the surface irregularities of the peel-off surfaces 11 and 21 of the ingots 1 or the wafers 20 as the peel-off surfaces 11 of the ingots 1 or the peel-off surfaces 21 of the wafers 20 are relatively moved and abraded against each other while in contact with each other.

The present invention is not limited to the above-mentioned embodiments. Rather, various changes and modifications may be made without departing from the scope of the invention. According to the second embodiment, etc., in the surface irregularity reducing step 1004, surface irregularities of the peel-off surfaces 11 and 21 of the ingot 1 or the wafer 20 as the first workpiece and the ingot 1 or the wafer 20 as the second workpiece are reduced. According to the present invention, however, surface irregularities of the contact surfaces 102 and 111 of at least either the first workpiece 101 or the second workpiece 110 may be reduced.

According to the present invention, the liquid supply means such as the liquid supply nozzle 52 for supplying the liquid 53 in the surface irregularity reducing apparatus 40 is not a requisite component. Stated otherwise, the surface irregularity reducing step 1004 may be carried out without the liquid 53 to be supplied. According to the present invention, moreover, the second holding table 25 used in the wafer manufacturing step 1002 may be used as the first holder 41, and the holder 38 used to hold the wafer 20 peeled off in the wafer manufacturing step 1002 may be used as the second holder 50. Providing the first holder 41 and the second holder 50 have holding surfaces for holding the workpieces 101 and 110, each of the first holder 41 and the second holder 50 may be a holding table having a base that supports the holding surface or a delivery arm having an arm for moving the holding surface.

The present invention is not limited to the details of the above-described preferred embodiments. The scope of the invention is defined by the appended claims and all changes and modifications as fall within the equivalence of the scope of the claims are therefore to be embraced by the invention.

What is claimed is:

1. A surface irregularity reducing method comprising:
a holding step of holding a first workpiece on a first holder and holding a second workpiece that is of a same material as the first workpiece on a second holder; and
a surface irregularity reducing step of moving the first holder and the second holder relatively to each other while the first workpiece held on the first holder and the second workpiece held on the second holder are being kept in contact with each other, thereby removing surface irregularities of a contact surface of at least either the first workpiece or the second workpiece.

2. The surface irregularity reducing method according to claim 1, further comprising:
after the surface irregularity reducing step, a grinding step of grinding the contact surface of at least either the first workpiece or the second workpiece with a grinding wheel.

3. The surface irregularity reducing method according to claim 1, wherein the surface irregularity reducing step includes a step of controlling a pressure under which the first workpiece and the second workpiece are pressed against each other.

4. The surface irregularity reducing method according to claim 1, further comprising:
before the holding step, a peel-off layer producing step of producing peel-off layers in an ingot by applying a laser beam having a wavelength transmittable through the ingot to the ingot while positioning a focused spot of the laser beam in the ingot at a depth from an end face of the ingot, the depth corresponding to a thickness of a wafer to be manufactured from the ingot; and
before the holding step, a wafer manufacturing step of manufacturing the wafer by peeling off a portion of the ingot as the wafer from the peel-off layers as separation initiating points,
wherein each of the first workpiece and the second workpiece is the ingot having a peel-off surface from which the wafer has been peeled off in the wafer manufacturing step or the wafer having a peel-off surface that has been peeled off from the ingot in the wafer manufacturing step, and,
in the surface irregularity reducing step, the peel-off surfaces of a combination of at least either an ingot and an ingot, a wafer and a wafer, or an ingot and a wafer are moved relatively to each other while in contact with each other.

5. A surface irregularity reducing apparatus comprising:
a first holder for holding a first workpiece thereon;
a second holder for holding thereon a second workpiece that is of a same material as the first workpiece held on the first holder, in facing relation to the first workpiece; and
a moving mechanism for moving the first holder and the second holder relatively to each other,
wherein the moving mechanism moves the first holder and the second holder relatively to each other while the first workpiece held on the first holder and the second workpiece held on the second holder are being kept in contact with each other, thereby removing surface irregularities of a contact surface of at least either the first workpiece or the second workpiece.

6. The surface irregularity reducing apparatus according to claim 5,
wherein the moving mechanism includes
a first moving unit for moving the first holder and the second holder relatively to each other in a direction parallel to the contact surface,
a second moving unit for moving the first holder and the second holder relatively toward and away from each other in a direction transverse to the contact surface, and
a pressure sensor mounted on at least either the first holder or the second holder for measuring a pressure produced when the first workpiece and the second workpiece are pressed against each other, and,
while the first moving unit is moving the first holder and the second holder relatively to each other while the first workpiece and the second workpiece are being kept in contact with each other, the second moving unit adjusts a distance between the first holder and the second holder in order for a measured value of the pressure from the pressure sensor to fall within a desired range.

7. The surface irregularity reducing apparatus according to claim 5,
wherein each of the first workpiece and the second workpiece is an ingot having a peel-off surface from which a wafer has been peeled off or the wafer having a peel-off surface that has been peeled off from the ingot, and
the moving mechanism moves peel-off surfaces of a combination of at least either an ingot and an ingot, a wafer and a wafer, or an ingot and a wafer relatively to each other while the peel-off surfaces are being kept in contact with each other.
